(19) United States
(12) Patent Application Publication
(10) Pub. No.: US 2020/0235356 A1
(43) Pub. Date: Jul. 23, 2020

(54) BUCKLING STRUCTURE FOR A BATTERY OF A HANDHELD POWER TOOL

(71) Applicant: Yu-Tang LIN, New Taipei City (TW)

(72) Inventors: Yu-Tang LIN, New Taipei City (TW); Hsien-Yu KAO, New Taipei City (TW)

(73) Assignee: Yu-Tang LIN, New Taipei City (TW)

(21) Appl. No.: 16/405,598

(22) Filed: May 7, 2019

(30) Foreign Application Priority Data
Jan. 22, 2019 (TW) 108201033

(51) Int. Cl. H01M 2/10; B25F 5/02

(52) U.S. Cl. CPC H01M 2/1022; H01M 2220/30; B25F 5/02

(57) ABSTRACT

A buckling structure for a battery of a handheld power tool has a handheld seat and a battery. The battery has a buckling assembly having a buckling component and a pressing component. The buckling component selectively buckles the handheld seat and forms an abutting slope. The pressing component forms a pressing slope. The pressing slope slidably abuts the abutting slope. When a user presses, the pressing slope pushes the abutting slope and makes the buckling component move downward. So the buckling structure can prevent direct manual pressing on the spring and further save effort by the two sliding slopes. Besides, the direction of the pressing force is parallel to the detaching direction of the handheld seat or the battery so the buckling structure will not generate unnecessary friction between the handheld seat and the battery. Therefore, the detaching progress becomes smoother.

### CROSS-REFERENCE TO RELATED APPLICATIONS

This application is based upon and claims priority under 35 U.S.C. 119 from Taiwan Patent Application No. 108201033 filed on Jan. 22, 2019, which is hereby specifically incorporated herein by this reference thereto.

### BACKGROUND OF THE INVENTION

### 1. Field of the Invention

The present invention relates to a tool, especially to a handheld power tool.

### 2. Description of the Prior Arts

A handheld power tool makes assembling or disassembling of objects easier and more effective. The handheld power tool uses a battery as a power source and is combined with a conventional hand tool such as a screwdriver or a drill so that people can use a handheld power instead of driving the hand tools manually.

The abovementioned handheld power tool has a driving assembly, a handheld seat, and a battery. The handheld seat has a protruding rib and the battery has a groove. The groove and the protruding rib are engaged with each other. The battery is detachably mounted on a bottom end of the handheld seat as a power source to drive the driving assembly which is mounted on a top end of the handheld seat. Thus, by mounting a hand tool such as a screwdriver or a drill on the driving assembly, a user is able to drive the hand tool by electricity instead of by manual force.

The abovementioned battery has a buckling component formed on a top surface thereof. The buckling component buckles the battery and the handheld seat as the protruding rib of the handheld seat reaches a front end of the groove after moving along the groove in order to prevent the battery and the handheld seat from detaching from each other. The buckling component is abutted by a spring inside the battery and protrudes from the top surface of the battery. When detaching the battery and the handheld seat, the user has to press a pressing segment of the buckling component to press the spring in order to make the buckling component retract into the top surface of the battery and unbuckle the battery and the handheld seat.

However, because of the abovementioned structure, by pressing the buckling component, the user is simultaneously pressing the spring directly downwards. Moreover, the manufacturer usually uses a spring with high elasticity to make sure the handheld seat and the battery are combined stably. So, detaching the handheld seat and the battery becomes a laborious task for the user. Besides, a direction of a force that presses the buckling component is perpendicular to a direction of a force that is exerted to detach the battery and the handheld seat. Thus, pressing the buckling component generates unnecessary friction between the groove and the protruding rib and makes the detaching progress more difficult.

To overcome the shortcomings, the present invention provides a buckling structure for a battery of a handheld power tool to mitigate or obviate the aforementioned problems.

### SUMMARY OF THE INVENTION

The main objective of the present invention is to provide a buckling structure for a battery of a handheld power tool that has an effort saving structure in the buckling assembly so that pressing the buckling assembly becomes easier. Alternatively, the buckling structure for a battery of a handheld power tool also changes the direction of the force that is applied by the user to push the buckling assembly. Therefore, the progress of detaching the handheld seat and the battery becomes smoother.

The buckling structure for a battery of a handheld power tool has a handheld seat and a battery. The handheld seat has at least one buckling segment formed on a bottom end of the handheld seat. The battery is detachably mounted on the bottom end of the handheld seat and has a casing and a buckling assembly. The casing has at least one buckling groove and at least one pressing groove. The at least one buckling groove is formed on a top surface of the casing. The at least one pressing groove is formed on a front surface of the casing and communicates with the at least one buckling groove. The buckling assembly is mounted on the casing and has at least one buckling component, at least one buckling resilient component, and at least one pressing component. The at least one buckling component is mounted in the at least one buckling groove of the casing and is able to move up and down. The at least one buckling component selectively protrudes out of the top surface of the casing and selectively buckles the at least one buckling segment of the handheld seat. Each one of the at least one buckling component has an abutting slope formed on a surface of the buckling component. The normal line of the abutting slope extends upwards and frontwards. The at least one buckling resilient component is mounted in the at least one buckling groove of the casing and upwardly presses the at least one buckling component. The at least one pressing component is mounted in the pressing groove of the casing and is able to move frontwards and rearwards. Each one of the at least one pressing component has a pressing slope formed on a surface of the pressing component. The normal line of the pressing slope extends downward and rearward. The pressing slope abuts the abutting slope of the at least one buckling component and is able to slide relative to the abutting slope.

The present invention comprises an abutting slope formed on the buckling component and a pressing slope formed on the pressing component. By abutting the abutting slope and the pressing slope to each other and making them movable relative to each other, the pressing slope will push the abutting slope and make the buckling component retract into the buckling groove of the casing when the user presses the pressing component. Therefore, the purpose to save effort will be achieved by using two slopes slidably abutting each other instead of pressing the spring directly. Besides, the direction of the force applied by the user to press the pressing component, which is from the front side to the back side, is parallel to the direction along which the handheld seat or the battery moves during detachment. Thus, in the beginning of the progress to detach the handheld seat and the battery, the force direction of the user that presses the pressing component will not generate unnecessary friction between the handheld seat and the battery. So, the progress of detaching the handheld seat and the battery becomes smoother.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a buckling structure for a battery of a handheld power tool in accordance with the present invention;

FIG. 2 is an exploded view of the buckling structure for a battery of a handheld power tool in FIG. 1;

FIG. 3 is a perspective view of the buckling structure for a battery of a handheld power tool in FIG. 1; showing the battery;

FIG. 4 is an exploded view of the buckling structure for a battery of a handheld power tool in FIG. 1; showing the buckling assembly and the casing;

FIGS. 5 and 6 are schematic views of the buckling structure for a battery of a handheld power tool in FIG. 1; showing the action of the buckling assembly; and

FIG. 7 is a schematic view of the buckling structure for a battery of a handheld power tool in FIG. 1; showing the direction along which the handheld seat and the battery move and the direction of the force that is applied by the user.

### DETAILED DESCRIPTION OF THE PREFERRED EMBODIMENTS

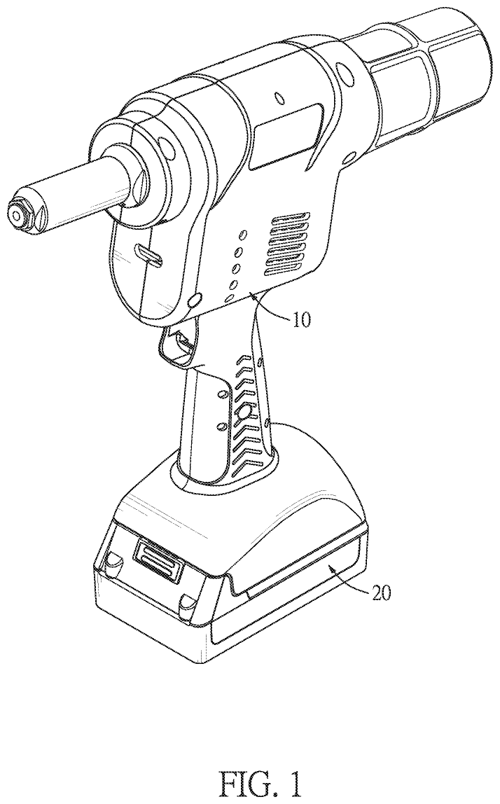

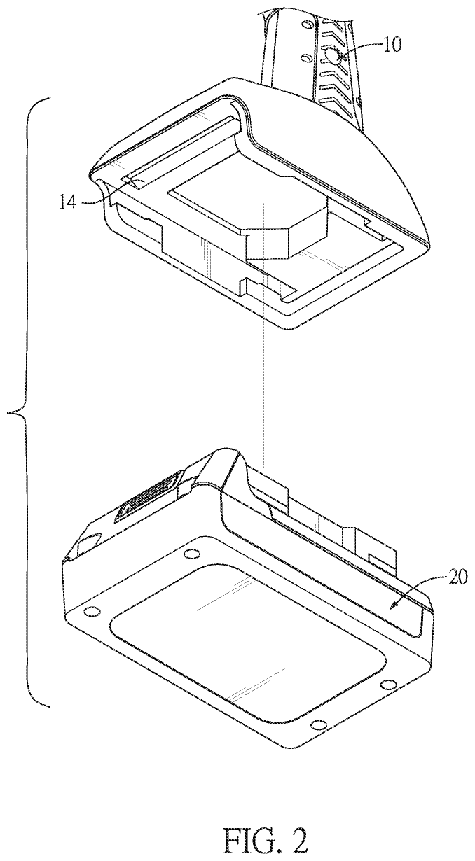

With reference to FIGS. 1 and 2, a buckling structure for a battery of a handheld power tool in accordance with the present invention comprises a handheld seat 10 and a battery 20.

The handheld seat 10 has at least one buckling segment 14 formed on a bottom end of the handheld seat 10.

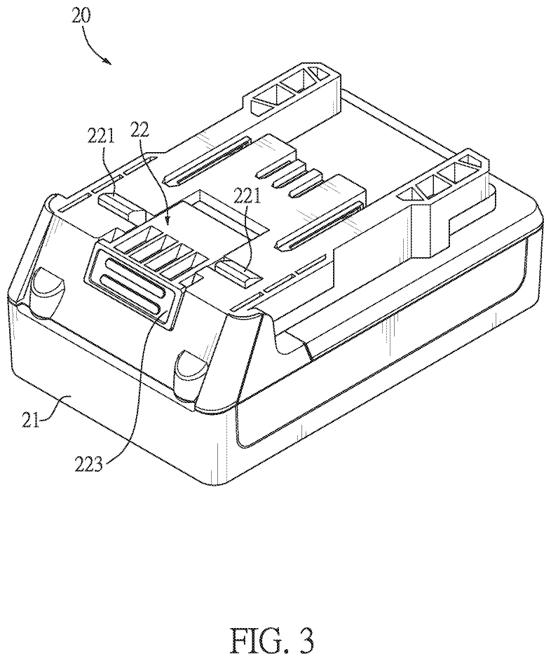

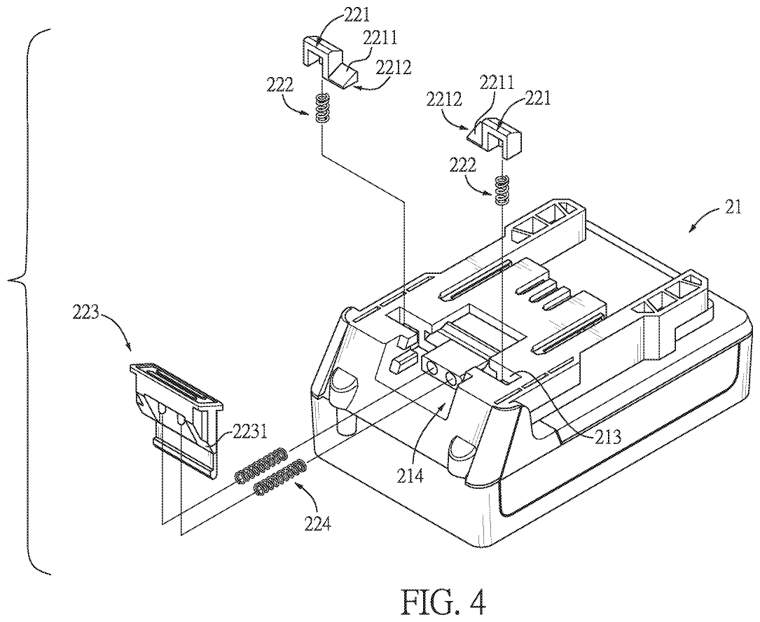

With further reference to FIGS. 3 and 4, the battery 20 is detachably mounted on the bottom end of the handheld seat 10 and has a casing 21 and a buckling assembly 22.

The casing 21 has at least one buckling groove 213 formed on a top surface of the casing 21 and at least one pressing groove 214 formed on a front surface of the casing 21. The pressing groove 214 communicates with the buckling groove 213.

The buckling assembly 22 is mounted on the casing 21 and has at least one buckling component 221, at least one buckling resilient component 222, and at least one pressing component 223. Specifically, in this embodiment, the amount of the at least one buckling segment 14 of the handheld seat 10 is one; the amount of the at least one buckling groove 213 of the casing 21 of the battery 20 is two; and the amount of the at least one pressing groove 214 is one. The two buckling grooves 213 are located in two sides of the pressing groove 214 respectively.

Moreover, in this embodiment, the amount of the at least one buckling component 221 is two; the amount of the at least one buckling resilient component 222 is two; and the amount of the at least one pressing component 223 is one.

The two buckling components 221 are mounted in the two buckling grooves 213 respectively and are able to move up and down. Each one of the two buckling components 221 selectively protrudes out of the top surface of the casing 21 and selectively buckles the buckling segment 14 of the handheld seat 10. Each one of the buckling components 221 has an abutting slope 2211 formed on a surface of the buckling component 221. The normal line of the abutting slope 2211 extends upwards and frontwards. In other words, the abutting slope 2211 faces up and inclines. Furthermore, each one of the buckling components 221 has an abutting segment 2212 extending into the pressing groove 214, and the abutting slope 2211 of each of the buckling components 221 is formed on the abutting segment 2212. That is, the abutting slope 2211 is located in the pressing groove 214 because of the abutting segment 2212. The structure of the buckling component 221 is not limited to the above mentioned, as the buckling component 221 can be implemented without the abutting segment 2212. In this way, the abutting slope 2211 is located in the buckling groove 213.

The two buckling resilient components 222 are mounted in the two buckling grooves 213 of the casing 21 respectively and upwardly press the two buckling components 221 respectively.

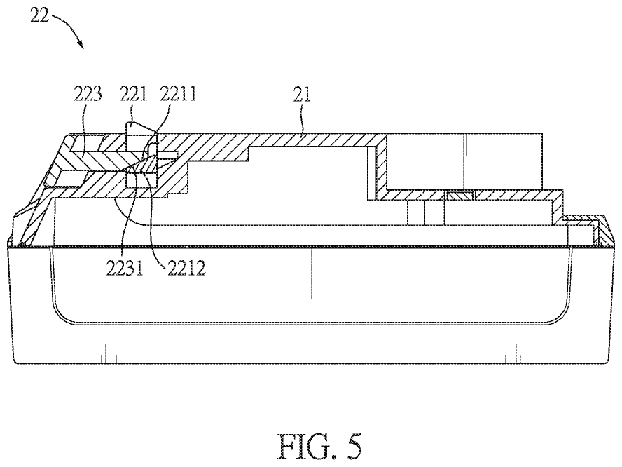

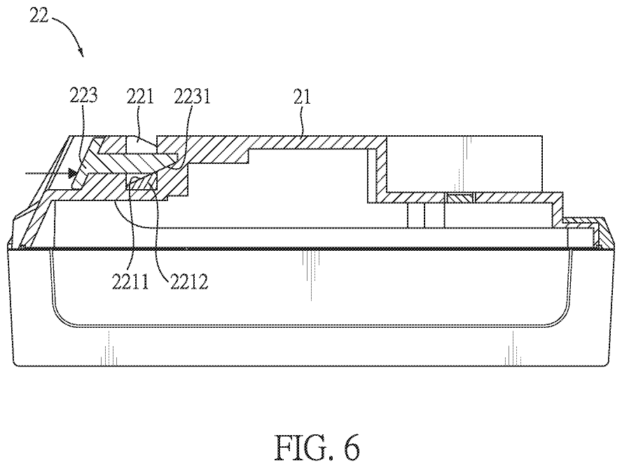

With further reference to FIGS. 5 and 6, the pressing component 223 is mounted in the pressing groove 214 and is able to move frontwards and rearwards. The pressing component 223 has a pressing slope 2231 formed on a surface thereof. The normal line of the pressing slope 2231 extends downwards and rearwards. In other words, the pressing slope 2231 faces down and inclines. The pressing slope 2231 abuts the two abutting slopes 2211 of the two buckling components 221 and is able to slide relative to the abutting slopes 2211. In other words, the two buckling components 221 are located in two sides of the pressing component 223 respectively, and the abutting segment 2212 of each of the buckling components 221 extends into the pressing groove 214 and is located beneath the pressing component 223. Thus, the abutting slope 2211, which is formed on the abutting segment 2212 of the buckling component 221, is able to abut the pressing slope 2231 of the pressing component 223 underneath the pressing component 223 and is able to slide relative to the pressing slope 2231.

Alternatively, in an embodiment that the abutting slope 2211 is located in the buckling groove 213, the pressing component 223 extends into the buckling groove 213 and forms the pressing slope 2231 in the buckling groove 213.

By the abovementioned structure, when a user presses the pressing component 223 from the front side to the rear side, the pressing slope 2231 will push the abutting slope 2211 and make the buckling component 221 retract into the buckling groove 213 by the sliding slopes. Therefore, the present invention is able to prevent from generating unnecessary friction by changing the force direction of the user with two slopes sliding relative to each other. Furthermore, the present invention prevents from manually pressing the buckling resilient component 222 directly and saves effort by the pressing slope 2231 and the abutting slope 2211 sliding relative to each other.

In addition, with further reference to FIG. 4, the buckling assembly 22 further comprises at least one pressing resilient component 224 mounted between the pressing component 223 and the casing 21, and pushes frontward the pressing component 223. The at least one pressing resilient component 224 contributes to restore the pressing component 223 to its initial position, but the buckling assembly 22 can be implemented without the pressing component 223. And, the amounts of the buckling component 221, the buckling resilient component 222, the pressing component 223, the buckling segment 14, the buckling groove 213, and the pressing groove 214 are not limited to the abovementioned, as long as each of them is at least one in amount, it will suffice to achieve the same effect.

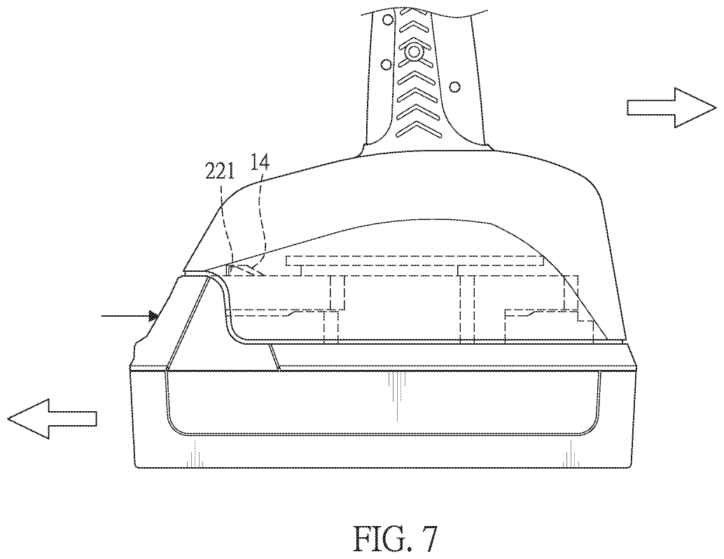

The present invention has two slopes sliding relative to each other between the pressing component 223 and the buckling component 221 so that the present invention is able to prevent from pushing the buckling resilient component 222 directly and is able to save effort by the sliding slopes when the user is detaching the handheld seat 10 and the battery 20. And, with reference to FIG. 7, the direction of the force that pushes the pressing component 223, which is from the front side to the rear side, is parallel to the direction that the handheld seat 10 or the battery 20 moves along when being detached. Therefore, in the beginning of the progress to detach the handheld seat 10 and the battery 20, the direction of the force applied by the user will not generate unnecessary friction between the handheld seat 10 and the battery 20. So, the detaching progress becomes smoother.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A buckling structure for a battery of a handheld power tool, the buckling structure comprising:
a handheld seat having at least one buckling segment formed on a bottom end of the handheld seat; and
a battery detachably mounted on the bottom end of the handheld seat and having
a casing having
at least one buckling groove formed on a top surface of the casing; and
at least one pressing groove formed on a front surface of the casing and communicating with the at least one buckling groove; and
a buckling assembly mounted on the casing and having
at least one buckling component mounted in the at least one buckling groove of the casing and being able to move up and down; the at least one buckling component selectively protruding out of the top surface of the casing and selectively buckling the at least one buckling segment of the handheld seat; each one of the at least one buckling component having an abutting slope formed on a surface of said buckling component; a normal line of the abutting slope extending upwards and frontwards;
at least one buckling resilient component mounted in the at least one buckling groove of the casing and upwardly pressing the at least one buckling component; and
at least one pressing component mounted in the at least one pressing groove of the casing and being able to move frontwards and rearwards; each one of the at least one pressing component having a pressing slope formed on a surface thereof; a normal line of the pressing slope extending downwards and rearwards; the pressing slope abutting the abutting slope of the at least one buckling component and being able to move relative to the abutting slope;
wherein when the at least one pressing component is pressed into the at least one pressing groove, the at least one pressing component presses the at least one buckling component to move downward into the at least one buckling groove via the slidable abutment between the pressing slope and the abutting slope.

2. The buckling structure as claimed in claim 1, wherein
an amount of the at least one buckling groove of the casing is two; an amount of the at least one pressing groove is one; the two buckling grooves are located in two sides of the pressing groove respectively;
an amount of the at least one buckling component of the buckling assembly is two; an amount of the at least one buckling resilient component is two; an amount of the at least one pressing component is one;
the two buckling components are mounted in the two buckling grooves of the casing respectively and are able to move up and down; each one of the two buckling components has an abutting segment extending into the pressing groove;
the abutting slope of each of the buckling component is formed on the abutting segment of said buckling component;
the two buckling resilient components are mounted in the two buckling grooves of the casing respectively and upwardly press the two buckling components respectively;
the pressing slope of the pressing component abuts the two abutting slopes of the two buckling components.

3. The buckling structure as claimed in claim 1, wherein the buckling assembly of the battery further comprises
at least one pressing resilient component mounted between the at least one pressing component and the casing; the at least one pressing resilient component pushes frontward the at least one pressing component.

4. The buckling structure as claimed in claim 2, wherein the buckling assembly of the battery further comprises
a pressing resilient component mounted between the pressing component and the casing; the pressing resilient component pushes frontward the pressing component.
